(19) United States
(12) Patent Application Publication
(10) Pub. No.: US 2004/0268151 A1
(43) Pub. Date: Dec. 30, 2004

(54) Maintenance/diagnosis data storage server

(75) Inventor: Katsuhiko Matsuda, Tokyo (JP)

Correspondence Address: Finnegan, Henderson, Farabow,, Garrett & Dunner, L.L.P., 1300 I Street, N.W., Washington, DC, 20005-3315, US

(73) Assignee: TOKYO ELECTRON LIMITED

(21) Appl. No.: 10/819,300

(22) Filed: Apr. 7, 2004

(30) Foreign Application Priority Data
Apr. 7, 2003 (JP) P2003-102817

(51) Int. Cl. H04L 9/00

(52) U.S. Cl. 713/201

(57) ABSTRACT

A maintenance/diagnosis data storage server includes: a data storing unit that obtains maintenance/diagnosis data pertaining to equipment that is connected to a first network, from the equipment via a first firewall, and stores the maintenance/diagnosis data; a request receiving unit that receives a data access request in which to request an access to the maintenance/diagnosis data, from a client provided for obtaining data and connected to a second network, via a second firewall; an authenticating unit that authenticates the data access request based on authentication information; and a data transmitting unit that transmits the maintenance/diagnosis data stored in the data storing unit to the client via the second firewall in a case where the authenticating unit authenticates the data access request is valid.

### BACKGROUND OF THE INVENTION

1. Field of the Invention

The present invention relates to a maintenance/diagnosis data storage server, and a system for storing maintenance/diagnosis data which are used for remotely performing maintenance and diagnosis of various types of equipment. More particularly, the present invention relates to a maintenance/diagnosis data storage server, and a system for storing maintenance/diagnosis data which are suitable for enhancing security.

2. Description of the Related Art

Conventional systems for remotely performing maintenance and diagnosis of equipment are disclosed in JP-A-2002-032274 and in JP-A-2000-207318. In the system disclosed in JP-2002-032274, equipment to be diagnosed is provided with security level determination control means for providing new access permission in accordance with the degree of an event associated with an inquiry made by the system that performs diagnosis.

In the system disclosed in JP-A-2000-207318, equipment to be remotely diagnosed is provided with means for arbitrarily classifying data to be sent to equipment which performs remote maintenance.

### SUMMARY OF THE INVENTION

The techniques described in the above two documents are focused on how to maintain the security of a link between equipment to perform maintenance/diagnosis (i.e., equipment that performs remote diagnosis) and equipment to be subjected to maintenance and diagnosis in a remote diagnosis/maintenance system (i.e., an owner of the equipment). An owner of equipment, such as manufacturing equipment, is considered to be susceptible to a loss due to unlimited distribution of equipment data, including manufacturing know-how.

Remote maintenance/diagnosis of equipment through use of a communication line, such as a network, has not been performed at a remote site but hitherto has been performed by means of a service engineer visiting to a business establishment or to a factory, where equipment is installed and in operation. Even in such a case, a relationship analogous to that mentioned above exists between equipment that performs maintenance/diagnosis and equipment to be subjected to maintenance/diagnosis. Consequently, in the sense of maintenance of security, security must be preserved in any case, regardless of whether or not maintenance/diagnosis is remote.

The present invention has been conceived in consideration of the above-described circumstances and focused on providing a maintenance/diagnosis data storage server, and a system for storing maintenance/diagnosis data which are used for remotely performing maintenance/diagnosis of various pieces of equipment and enable an attempt to maintain the same security as achieved in a case where maintenance/diagnosis is performed locally rather than remotely.

In order to solve the problem, according to a first aspect of the invention, there is provided a maintenance/diagnosis data storage server including: a data storing unit that obtains maintenance/diagnosis data pertaining to equipment that is connected to a first network, from the equipment via a first firewall, and stores the maintenance/diagnosis data; a request receiving unit that receives a data access request in which to request an access to the maintenance/diagnosis data, from a client provided for obtaining data and connected to a second network, via a second firewall; an authenticating unit that authenticates the data access request based on authentication information; and a data transmitting unit that transmits the maintenance/diagnosis data stored in the data storing unit to the client via the second firewall in a case where the authenticating unit authenticates the data access request is valid.

According to a second aspect of the invention, there is provided a maintenance/diagnosis data storage system including: a maintenance/diagnosis data storage server connected to a first network via a first firewall; and a client for obtaining a maintenance/diagnosis data connected to the first network, wherein the client includes: a request transmitting unit that transmits a data access request in which to request an access to maintenance/diagnosis data, to the maintenance/diagnosis data server via the first firewall; and a data receiving unit that receives the maintenance/diagnosis data from the maintenance/diagnosis data server via the first firewall, wherein the maintenance/diagnosis data server includes: a data storing unit that obtains the maintenance/diagnosis data pertaining to equipment that is connected to a second network, from the equipment via a second firewall, and stores the maintenance/diagnosis data; a request receiving unit that receives the data access request from the client; an authenticating unit that authenticates the data access request based on authentication information; and a data transmitting unit that transmits the maintenance/diagnosis data stored in the data storing unit to the client via the first firewall in a case where the authenticating unit authenticates the data access request is valid.

According to a third aspect of the invention, there is provided a maintenance/diagnosis data storage system including: an equipment connected to a first network; and a maintenance/diagnosis data storage server connected to the first network via a first firewall, and connected to a second network via a second firewall, wherein the maintenance/diagnosis data storage server includes: a data storing unit that obtains maintenance/diagnosis data pertaining to the equipment, from the equipment via a first firewall, and stores the maintenance/diagnosis data; a request receiving unit that receives a data access request in which to request an access to the maintenance/diagnosis data, from a client provided for obtaining data and connected to the second network, via the second firewall; an authenticating unit that authenticates the data access request based on authentication information; and a data transmitting unit that transmits the maintenance/diagnosis data stored in the data storing unit to the client via the second firewall in a case where the authenticating unit authenticates the data access request is valid.

### BRIEF DESCRIPTION OF THE DRAWINGS

These and other objects and advantages of the present invention will become more fully apparent from the following detailed description taken with the accompanying drawings, in which:

FIG. 1 is a view showing a configuration according to a first embodiment of the present invention;

FIG. 2 is a block diagram showing a configuration of the maintenance/diagnosis data storage server;

FIG. 3 is a flowchart showing a flow of operation of a client 26 (27) shown in FIG. 1;

FIG. 4 is a flowchart showing a flow of operation of a maintenance/diagnosis data storage server 23 shown in FIG. 1;

FIG. 5 is a flowchart showing a flow of operation of the pieces of the semiconductor manufacturing equipment 5, 6, and 7 or operation of the group management server 4, which are shown in FIG. 1;

FIG. 6 is a view showing a configuration according to a second embodiment of the present invention;

FIG. 7 is a flowchart showing a flow of operation of the client 26 (27) shown in FIG. 6;

FIG. 8 is a flowchart showing a flow of operation of a maintenance/diagnosis data storage server 23A shown in FIG. 6;

FIG. 9 is a flowchart showing a flow of operation of the pieces of the semiconductor manufacturing equipment 5, 6, and 7 or operation of the group management server 4, which are shown in FIG. 6;

FIG. 10 is a view showing a configuration according to a third embodiment of the present invention;

FIG. 11 is a flowchart showing a flow of operation of the client 26 (27) shown in FIG. 10;

FIG. 12 is a flowchart showing a flow of operation of a maintenance/diagnosis data storage server 23 shown in FIG. 10;

FIG. 13 is a flowchart showing a flow of operation of the pieces of the semiconductor manufacturing equipment 5A, 6A, and 7A or operation of the group management server 4, which are shown in FIG. 10; and

FIG. 14 is a flowchart showing a flow of operation of a user authentication information storage server 28 shown in FIG. 10.

### DETAILED DESCRIPTION OF THE PREFERRED EMBODIMENTS

Referring now to the accompanying drawings, a description will be given in detail of preferred embodiments according to the invention.

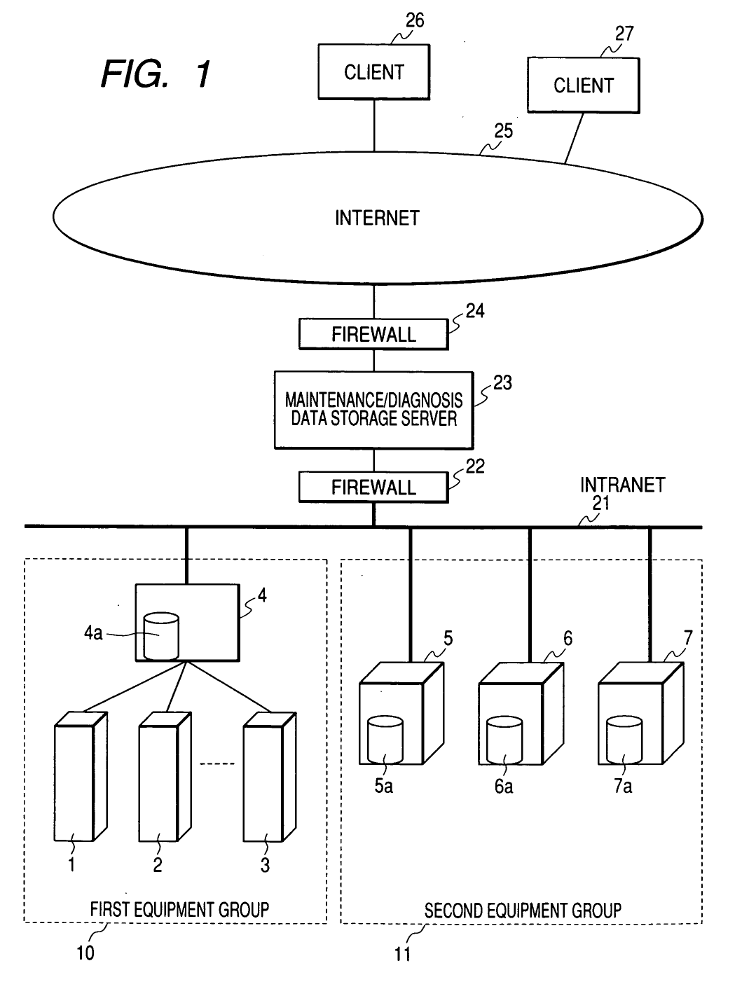

FIG. 1 is a view showing a configuration achieved when a maintenance/diagnosis data storage server, and a system for storing maintenance/diagnosis data, all pertaining to an embodiment of the present invention, are used for a semiconductor manufacturing apparatus which is to be subjected to maintenance and diagnosis.

As shown in FIG. 1, the system according to a first embodiment includes: a first equipment group 10; a second equipment group 11; an intranet 21; a firewall 22; an maintenance/diagnosis data storage server 23; a firewall 24; the Internet 25; and clients 26, 27.

The first equipment group 10 includes; a plurality of semiconductor manufacturing equipments 1, 2, and 3; and a group management server 4. The group management server 4 manages operations of the respective semiconductor manufacturing equipments 1, 2, and 3. Maintenance/diagnosis data pertaining to the respective semiconductor manufacturing equipments 1, 2, and 3 resulting from management are output from the group management server 4 to the maintenance/diagnosis data storage server 23 via intranet 21 connected thereto. The semiconductor manufacturing equipments 1, 2, and 3 are not limited to any specific types and may be embodied as a diffusion furnace, for example. The semiconductor manufacturing equipments 1, 2, and 3 have been supplied by a certain manufacturer of semiconductor manufacturing equipment, and a person having some relationship with the manufacturer is in charge of conducting maintenance/diagnosis of the semiconductor manufacturing equipments 1, 2, and 3.

The group management server 4 is equipped with a user authentication information database 4a. When a command for requesting authentication of a user has been input from the maintenance/diagnosis data storage server 23 via intranet 21, authentication of the user is performed by reference to user authentication information retained in the user authentication information database 4a. Results of execution are output to the maintenance/diagnosis data storage server 23 via the intranet 21.

The second equipment group 11 includes a plurality of semiconductor manufacturing equipments 5, 6, and 7. The semiconductor manufacturing equipments 5, 6, and 7 are connected individually to the intranet 21 without involvement of a server that performs central management as does the group management server 4. The semiconductor manufacturing equipments 5, 6, and 7 are not limited to any specific types but can be embodied as, e.g., resist coating equipment or development equipment. The semiconductor manufacturing equipments 5, 6, and 7 have been supplied to the semiconductor manufacturer from another manufacturer of semiconductor manufacturing equipment, and a person who has some relationship with the other manufacturer of semiconductor manufacturing equipment is in charge of conducting maintenance/diagnosis of the semiconductor manufacturing equipments 5, 6, and 7.

The semiconductor manufacturing equipment 5 has a user authentication information database 5a ; the semiconductor manufacturing equipment 6 has a user authentication information database 6a ; and the semiconductor manufacturing equipment 7 has a user authentication information database 7a. When a command for requesting authentication of a user has been input from the maintenance/diagnosis data storage server 23 via intranet 21, the user is authenticated by reference to the user authentication information stored in the respective user authentic information databases 5a, 6a, and 7a. A result of authentication is output to the maintenance/diagnosis data storage server 23 via the intranet 21. The maintenance/diagnosis data are output to the maintenance/diagnosis data storage server 23 via the intranet 21, as required.

Other equipment groups may exist in addition to the equipment groups 10 and 11. In such a case, the other equipment groups are also connected to the maintenance/diagnosis data storage server 23 via the intranet 21. Manufacturers of the other equipment groups may differ from the manufacture of the above-described semiconductor manufacturing equipments. Moreover, no limitations are imposed on the number of pieces of semiconductor manufacturing equipments constituting the equipment groups.

As mentioned above, the intranet 21 is connected to the equipment groups 10 and 11. The intranet 21 is further connected to the maintenance/diagnosis data storage server 23 by way of the firewall 22 having a comparatively high level of security. The intranet 21 is, e.g., a local area network (LAN) laid within a production plant of the semiconductor manufacturer.

The firewall 22 is a defensive wall interposed between the intranet 21 and the maintenance/diagnosis data storage server 23. The firewall 22 prevents unauthorized access to the equipment groups 10, 11 from the Internet 25 while maintaining a high level of security. Therefore, information, such as data belonging to each of the semiconductor manufacturing equipments 1, 2, 3, 5, 6, and 7, is protected.

The maintenance/diagnosis data storage server 23 is for collecting maintenance/diagnosis data pertaining to the pieces of semiconductor manufacturing equipment 1, 2, 3, 5, 6, and 7 by way of the intranet 21 and storing the thus-collected data. When a data access request has been made by the Internet 25, the maintenance/diagnosis data storage server 23 requests the group management serve 4 or the pieces of semiconductor manufacturing equipment 5, 6, and 7 to authenticate the user by way of the firewall 22 and the intranet 21 on the basis of the data access request, and receives a result of authentication. When the received result of authentication is normal, the stored maintenance/diagnosis data are output to the Internet 25 on the basis of the data access request from the Internet 25.

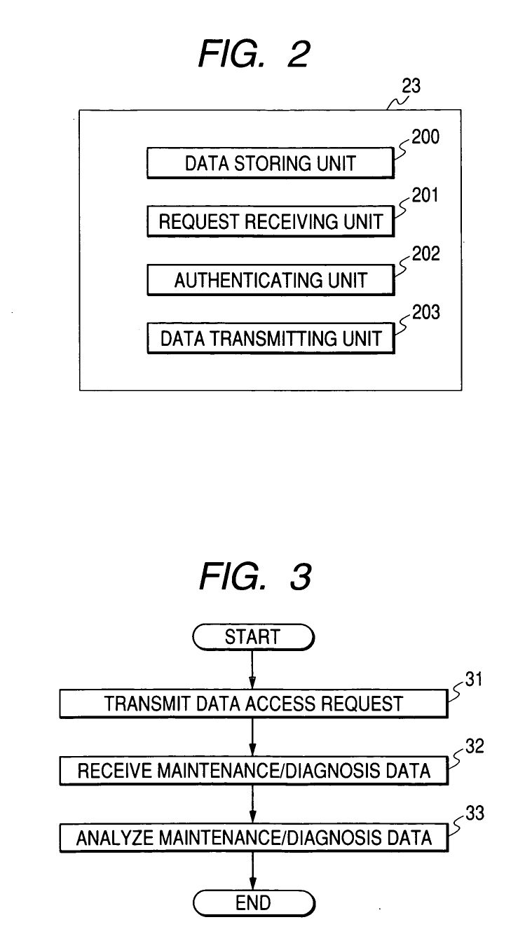

As shown in FIG. 2, the maintenance/diagnosis data storage server 23 includes: a data storing unit 200 that obtains the maintenance/diagnosis data pertaining to the pieces of semiconductor manufacturing equipment 1, 2, 3, 5, 6, and 7 that is connected to the intranet 21, from the equipments via the firewall 22, and stores the maintenance/diagnosis data; a request receiving unit 201 that receives a data access request in which to request an access to the maintenance/diagnosis data, from the client 26, 27 provided for obtaining data and connected to the Internet 25, via the firewall 24; an authenticating unit 202 that authenticates the data access request based on authentication information; and a data transmitting unit 203 that transmits the maintenance/diagnosis data stored in the data storing unit 200 to the client 26, 27 via the firewall 24 in a case where the authenticating unit 202 authenticates the data access request is valid.

In the first embodiment, the authenticating unit 202 is configured to include: an authentication request transmitting section that transmits an authentication request to the equipment; and an authentication result receiving section that receives an authentication result made by the equipment based on the authentication information stored in the equipment.

However, the authenticating unit 202 may be configured to include: an authentication information obtaining section that obtains the authentication information stored in the equipment, from the equipment; and an authentication performing section that performs an authentication of the data access request based on the authentication information obtained by the authentication information obtaining section.

The authenticating unit 202 may also be configured to include: a copied authentication information storing section that obtains the authentication information stored in the equipment via the firewall 22, and stores the authentication information as a copied authentication information; and an authentication performing section that performs an authentication of the data access request based on the copied authentication information stored in the copied authentication information storing section.

The authenticating unit 202 may also be configured to include: an authentication request transmitting section that transmits an authentication request via the firewall 22 to an authentication information storage server, which will be described later as a user authentication information storage server 28, which is connected to the intranet 21; and an authentication result receiving section that receives an authentication result made by the authentication information storage server based on the authentication information stored in the authentication information storage server.

The authenticating unit 202 may also be configured to include: an authentication information obtaining section that obtains the authentication information stored in an authentication information storage server, which will be described later as a user authentication information storage server 28, which is connected to the intranet 21, from the authentication information storage server via the firewall 22; and an authentication performing section that performs an authentication of the data access request based on the authentication information obtained by the authentication information obtaining section.

The firewall 24 is a defensive wall interposed between the maintenance/diagnosis data storage server 23 and the Internet 25. The firewall 24 is lower in security than the firewall 22, and, as a result, access from the Internet 25 to the maintenance/diagnosis data storage server 23 by way of the firewall 24 is comparatively easy. The reason for this is that maintenance/diagnosis data storage server 23 is mainly intended for providing stored maintenance/diagnosis data to clients 26, 27. When viewed from the Internet 25, a space existing between the firewalls 22 and 24 can be deemed a so-called DMZ (Demilitarized Zone).

The Internet 25 is connected to the maintenance/diagnosis data storage server 23 by way of the firewall 24 as well as to the clients 26, 27. As is well known, the Internet 25 is a network built as a general-purpose data communications network.

The clients 26, 27 are for acquiring maintenance/diagnosis data, making access to the maintenance/diagnosis data storage server 23 by way of the Internet 25, receiving the maintenance/diagnosis data, and analyzing the thus-received data. The clients 26, 27 are installed in the business establishment having some relationship with the previously-described manufacturer of the semiconductor manufacturing equipment, in order to perform remote maintenance/diagnosis of the semiconductor manufacturing equipment that has been delivered and is in operation.

The client 26 is assumed to be associated with the first equipment group 10, and the client 27 is assumed to be associated with the second equipment group 11. As mentioned above, the clients are basically present in accordance with the number of suppliers of equipment groups. In contrast, the maintenance/diagnosis data storage server 23 is unique and is used in relation to the semiconductor manufacturer, regardless of the number of suppliers of the equipment groups. Requests to access the data stored in the maintenance/diagnosis data storage server 23 are identified by means of user authentication.

Next, operation of the configuration shown in FIG. 1 will be described by reference to flowcharts shown in FIGS. 3 through 5. FIG. 3 is a flowchart showing the flow of operation of the client 26 (27) shown in FIG. 1. As shown in FIG. 3, the client 26 (27) first transmits a data access request to the maintenance/diagnosis data storage server 23 by way of the firewall 24 over the Internet 25 (step 31). The data access request includes a request for user authentication and a request for outputting a desired data set from the stored maintenance/diagnosis data.

As will be described later, if the maintenance/diagnosis data storage server 23 responds to the request and performs normal operation, the maintenance/diagnosis data storage server 23 outputs and transmits the maintenance/diagnosis data. Thus, the client 26 (27) receives the data by way of the firewall 24 over the Internet 25 (step 32). The thus-received data are analyzed, and maintenance/diagnosis processing is performed (step 33). Subsequently, software, such as a prescription program, may be transmitted to the maintenance/diagnosis data storage server 23 by way of the Internet 25 and the firewall 24 on the basis of the result of processing.

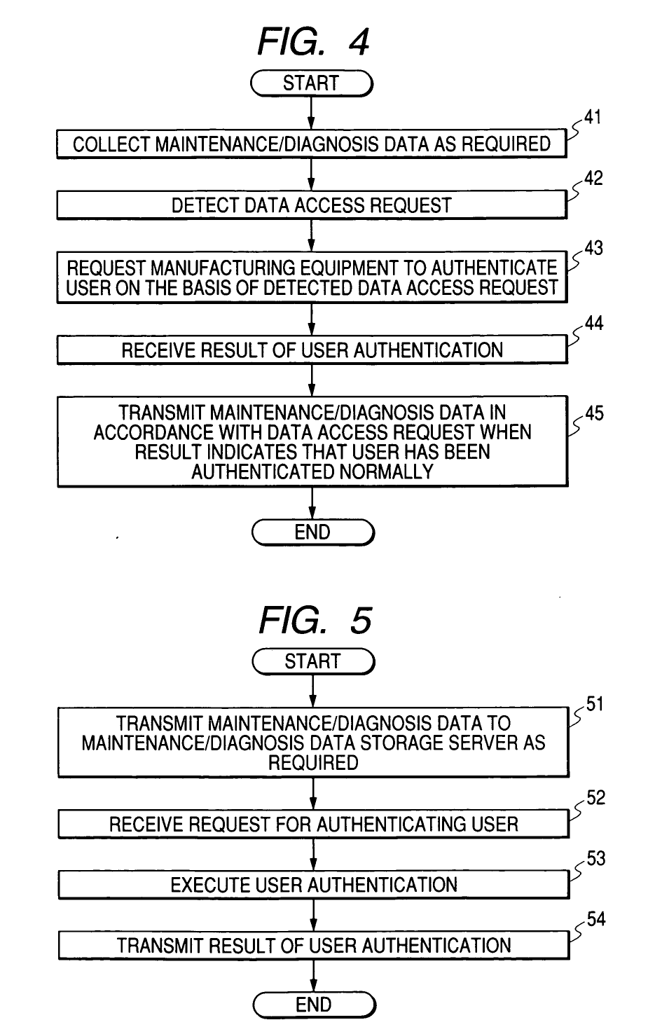

FIG. 4 is a flowchart showing the flow of operation of the maintenance/diagnosis data storage server 23 shown in FIG. 1. As shown in FIG. 4, the maintenance/diagnosis data storage server 23 has collected the maintenance/diagnosis data beforehand from the group management server 4 or the semiconductor manufacturing equipments 5, 6, and 7 by way of the firewall 22 and the intranet 21 and stored the thus-collected data, as required (step 41). Such collecting and storing operations can be performed periodically or nonperiodically.

A data access request from the Internet 25 is monitored and detected (step S42). If the data access request has been detected, the semiconductor manufacturing equipments 5, 6, and 7 or the group management server 4 is required to authenticate the user by way of the firewall 22 and the intranet 21 in accordance with the data access request (step S43). The reason for this is that the semiconductor manufacturing equipments 5, 6, and 7 or the group management server 4 possess the user authentication information (as mentioned previously, the user authentication information is stored in the user authentication information databases 5a, 6a, 7a, and 4a). On the basis of the respective data access requests, semiconductor manufacturing equipment or an equipment group, which is an object of user authentication, is specified.

In response to the request for user authentication, the specified pieces of semiconductor manufacturing equipment 5, 6, or 7 or the group management server 4 performs user authentication as will be described later. If the user authentication is normal, a result of user authentication is transmitted. The maintenance/diagnosis data storage server 23 receives the result by way of the intranet 21 and the firewall 22 (step 44).

When the result indicates that the user has been properly authenticated, a desired data set from among the stored maintenance/diagnosis data is output and transmitted to the maintenance/diagnosis data storage server 23 via the Internet 25 by way of the firewall 24 in accordance with the data access request (step 45). The thus-transmitted data are received by the client 26 (27) over the Internet 25, as mentioned previously.

FIG. 5 is a flowchart showing the flow of operation of the group management server 4 or operations of the pieces of the semiconductor manufacturing equipment 5, 6, and 7, which are shown in FIG. 1. Here, only operations which arise as a result of establishment of connection with the intranet 21 are described as operations of the semiconductor manufacturing equipments 5, 6, and 7. As a matter of course, operations intrinsic to manufacture of a semiconductor (e.g., operation of a resist coating/development apparatus) are performed separately.

By way of the intranet 21 and the firewall 22, the group management server 4 or the pieces of semiconductor manufacturing equipment 5, 6, and 7 send to the maintenance/diagnosis data storage server 23 the maintenance/diagnosis data pertaining to the semiconductor manufacturing equipment under control of the group management server 4 or the maintenance/diagnosis data pertaining to the semiconductor manufacturing equipment 5, 6, and 7, as required (step 51). As mentioned previously, this operation can be performed periodically or nonperiodically.

The group management server 4 or the pieces of semiconductor manufacturing equipment 5, 6, and 7 stay in standby condition so as to be able to receive a request for user authentication from the maintenance/diagnosis data storage server 23 (step 52). The request for user authentication is made by means of specifying semiconductor manufacturing equipment or an equipment group, which is an object of the request. The pieces of semiconductor manufacturing equipment 5, 6, and 7 or the group equipment server 4, which have received the request over the intranet 21, execute the request by reference to the user authentication information stored in the user authentication information databases 5a, 6a, 7a, and 4a (step 53). A result of execution is transmitted to the maintenance/diagnosis data storage server 23 by way of the intranet 21 and the firewall 22 (step 54).

According to the configuration that has been described thus far and comprises the client 26 (27), the maintenance/diagnosis data storage server 23, the group management server 4, and the pieces of semiconductor manufacturing equipment 5, 6, and 7, the same result of user authentication is yielded regardless of whether maintenance/diagnosis is performed remotely or a maintenance engineer visits the production plant, where the pieces of semiconductor manufacturing equipment 5, 6, and 7 are installed, and directly performs maintenance/diagnosis of these pieces of semiconductor manufacturing equipment.

The reason for this is that these two cases are identical with each other in terms of user authentication being performed through use of the user authentication information stored in the group management server 4 and the pieces of semiconductor manufacturing equipment 5, 6, and 7 (i.e., the user authentication information databases 4a, 5a, 6a, and 7a). Specifically, in the case of remote maintenance/diagnosis, user authentication is performed by direct reference to the user authentication information stored in the group management server 4 or the pieces of semiconductor manufacturing equipment 5, 6, and 7. The user authentication information employed at that time is identical with that used when an access is made not remotely but directly to the group management server 4 or the respective pieces of semiconductor manufacturing equipment 5, 6, and 7. Therefore, even in the case of remote maintenance/diagnosis, security analogous to that achieved in a case where maintenance/diagnosis is performed directly can be maintained between the equipment which performs maintenance/diagnosis (i.e., equipment which performs remote diagnosis) and the equipment to be subjected to maintenance/diagnosis (i.e., the owner of the equipment).

In contrast, for instance, when user authentication, which is valid only between the client 26 (27) and the maintenance/diagnosis data storage server 23, is performed through use of user authentication information uniquely retained in the maintenance/diagnosis data storage server 23, a result of user authentication usually differs from a result of user authentication performed when the pieces of semiconductor manufacturing equipment 5, 6, and 7 or the group management server 4 is subjected to direct maintenance/diagnosis. The reason for this is that there is no guarantee that the user authentication information is identical. As a result, the level of security existing between the equipment which performs maintenance/diagnosis (i.e., the equipment which performs remote diagnosis) and the equipment to be subjected to maintenance/diagnosis (the owner of the equipment) varies on a case by case basis, thereby hindering appropriate operation of the semiconductor manufacturing equipment.

In order to prevent occurrence of such a mismatch between the user authentication information items, elaborate maintenance pertaining to user authentication information must be performed, making the maintenance job excessively complicated. In particular, the maintenance/diagnosis data storage server 23 is basically provided as a common server regardless of the number of manufacturers of semiconductor manufacturing equipment, and hence the degree of complication of a maintenance job becomes much greater. However, the configuration shown in FIG. 1 resolves such complication.

In the first embodiment, the authentication is performed by the group management server 4 and the pieces of semiconductor manufacturing equipment 5, 6, and 7. However, the authentication may be performed by the maintenance/diagnosis data storage server 23.

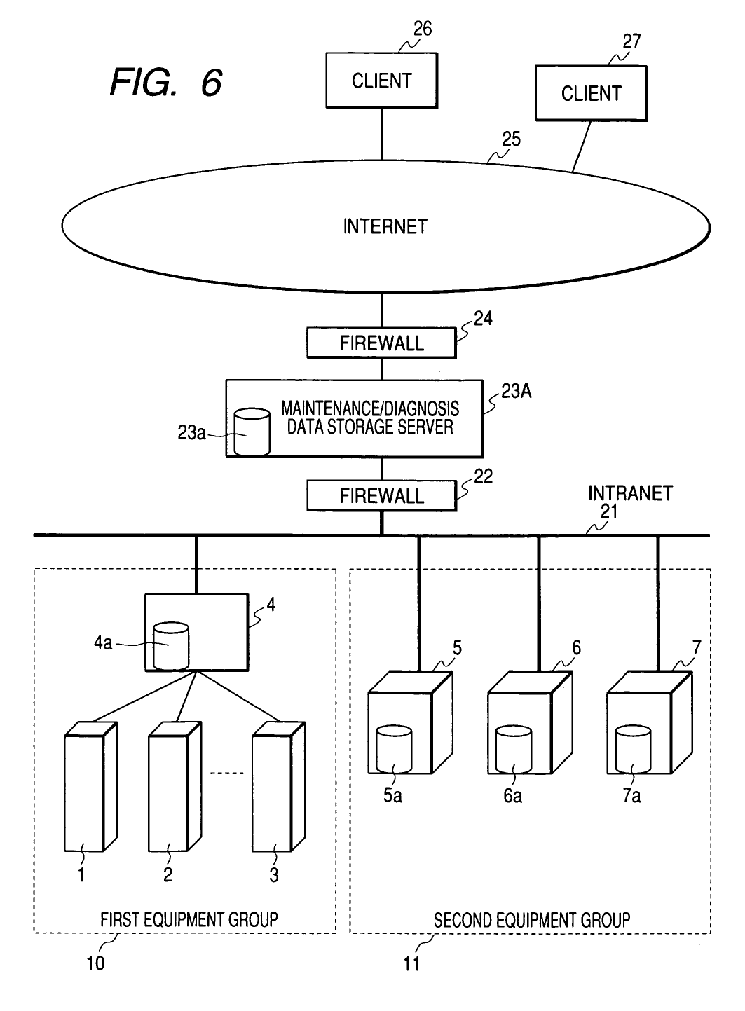

Next, a maintenance/diagnosis data storage server, and a system for storing maintenance/diagnosis data, all pertaining to a second embodiment of the present invention, will be described by reference to FIG. 6. FIG. 6 is a view showing a configuration achieved when the maintenance/diagnosis data storage server, the system for storing maintenance/diagnosis data, all pertaining to the second embodiment of the present invention, are used for a semiconductor manufacturing apparatus which is to be subjected to maintenance and diagnosis. Those constituent elements which have already been described by reference to FIG. 1 are assigned the same symbols, and their repeated explanations are omitted herein.

A difference between the second embodiment and the first embodiment lies in employment of a user authentication information database 23a of a maintenance/diagnosis data storage server 23A and the user authentication information database 23a being caused to retain copies of the user authentication information items owned by the group management server 4 and the pieces of semiconductor manufacturing equipment 5, 6, and 7.

When a data access request has been made by either of the clients 26, 27 via the Internet 25, the maintenance/diagnosis data storage server 23A authenticates the user on the basis of the request by reference to the copied user authentication information held in the authentication information database 23a. When a result of user authentication is normal, the stored maintenance/diagnosis data are output to either of the clients 26, 27, which has made the data access request, via the Internet 25. The maintenance/diagnosis data storage server 23A has been previously arranged to make an access to the group management server 4 and the pieces of semiconductor manufacturing equipment 5, 6, and 7 by way of the firewall 22 and the intranet 21, to thus acquire copies of the user authentication information owned by the same.

When submission of user authentication information is requested by the maintenance/diagnosis data storage server 23A by way of the firewall 22 and the intranet 21, the user authentication information retained in the user authentication information database 4a is output to the maintenance/diagnosis data storage server 23A via the intranet 21 in response to the request.

Similarly, when submission of user authentication information is requested by the maintenance/diagnosis data storage server 23A by way of the firewall 22 and the intranet 21, in response to the request the pieces of semiconductor manufacturing equipment 5, 6, and 7 output the user authentication information retained in the user authentication information databases 5a, 6a, and 7a to the maintenance/diagnosis data storage server 23A via the intranet 21.

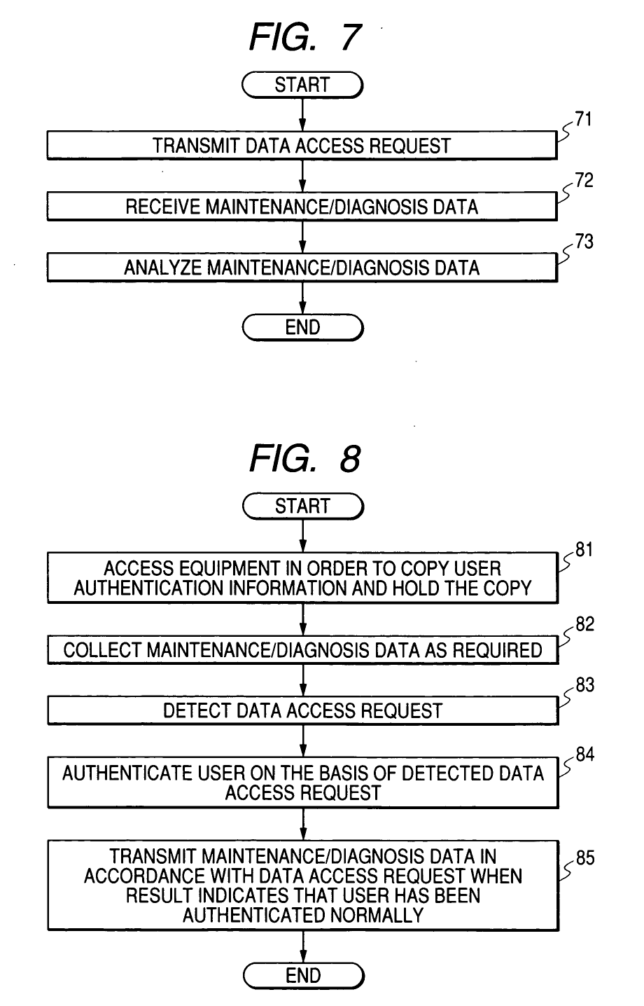

Next, operation of the configuration shown in FIG. 6 will be described by reference to the flowcharts shown in FIGS. 7 through 9. FIG. 7 is a flowchart showing the flow of operation of the client 26 (27) shown in FIG. 6. As shown in FIG. 7, the client 26 (27) first transmits a data access request to the maintenance/diagnosis data storage server 23 by way of the firewall 24 over the Internet 25 (step 71). The data access request includes a request for user authentication and a request for outputting a desired data set from the stored maintenance/diagnosis data.

As will be described later, if the maintenance/diagnosis data storage server 23A responds to the request and performs normal operation, the maintenance/diagnosis data storage server 23A outputs and transmits the maintenance/diagnosis data. Thus, the client 26 (27) receives the data by way of the firewall 24 over the Internet 25 (step 72). The thus-received data are analyzed, and maintenance/diagnosis processing is performed (step 73). Subsequently, software, such as a prescription program, may be transmitted to the maintenance/diagnosis data storage server 23A by way of the Internet 25 and the firewall 24 on the basis of the result of processing. The operation shown in FIG. 6 is identical with the operation that has already been described and is shown in FIG. 3.

FIG. 8 is a flowchart showing the flow of operation of the maintenance/diagnosis data storage server 23A shown in FIG. 6. As shown in FIG. 8, the maintenance/diagnosis data storage server 23A has made an access to the group management server 4 or the pieces of semiconductor manufacturing equipment 5, 6, and 7 by way of the firewall 22 and the intranet 21 beforehand, to thus acquire copies of the user authentication information items, and holds the copies as copied user authentication information in the user authentication information database 23a (step 81). As required, the maintenance/diagnosis data have been collected in advance from the group management server 4 or the pieces of semiconductor manufacturing equipment 5, 6, and 7 by way of the firewall 22 and the intranet 21, and the thus-collected data are stored (step 82). The collection and storing operations can be performed periodically or nonperiodically.

A data access request from the clients 26, 27 via Internet 25 is monitored and detected (step S83). If the data access request has been detected, the user is authenticated in accordance with the request by reference to the copied user authentication information retained in the user authentication information database 23a (step 84). Semiconductor manufacturing equipment or an equipment group, which is an object of user authentication, has been specified on the basis of the respective data access requests, and hence reference is made to corresponding copied user authentication information.

When the user has been properly authenticated, a desired data set from among the stored maintenance/diagnosis data is output and transmitted to the Internet 25 by way of the firewall 24 in accordance with the data access request (step 85). The thus-transmitted data are received by the client 26 (27) over the Internet 25, as mentioned previously.

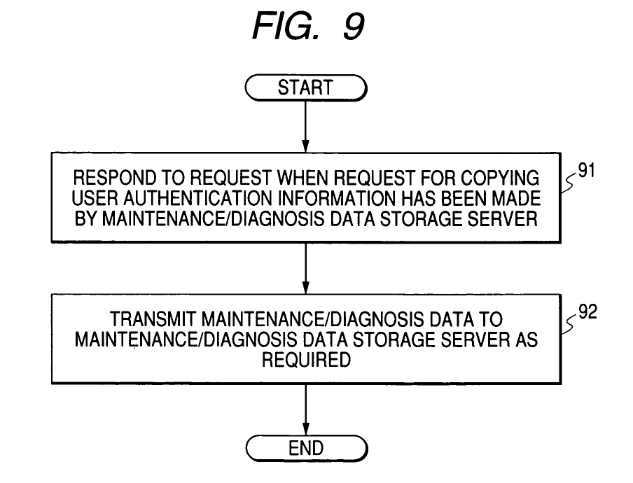

FIG. 9 is a flowchart showing the flow of operation of the group management server 4 or operations of the pieces of the semiconductor manufacturing equipment 5, 6, and 7, which are shown in FIG. 6. Here, only operations which arise as a result of establishment of connection with the intranet 21 are described as operations of the pieces of semiconductor manufacturing equipment 5, 6, and 7. As a matter of course, operations intrinsic to manufacture of a semiconductor (e.g., the operation of a resist coating/development apparatus) are performed separately.

Upon receipt of a request for copying user authentication information from the maintenance/diagnosis data storage server 23A by way of the firewall 22 and the intranet 21, in accordance with the request, the group management server 4 and the pieces of semiconductor manufacturing equipment 5, 6, and 7 output user authentication information to the maintenance/diagnosis data storage server 23A via the intranet 21 (step 91).

By way of the intranet 21 and the firewall 22, the group management server 4 or the pieces of semiconductor manufacturing equipment 5, 6, and 7 send to the maintenance/diagnosis data storage server 23A the maintenance/diagnosis data pertaining to the semiconductor manufacturing equipment under control of the group management server 4 or the maintenance/diagnosis data pertaining to the semiconductor manufacturing equipment 5, 6, and 7, as required (step 92). This operation can be performed periodically or nonperiodically.

According to the configuration that has been described thus far and includes the client 26 (27), the maintenance/diagnosis data storage server 23, the group management server 4, and the pieces of semiconductor manufacturing equipment 5, 6, and 7, the same result of user authentication is yielded regardless of whether maintenance/diagnosis is performed remotely or a maintenance engineer visits the production plant where the pieces of semiconductor manufacturing equipment 1, 2, 3, 5, 6, and 7 are installed and directly performs maintenance/diagnosis of these pieces of semiconductor manufacturing equipment.

The reason for this is that the user authentication information retained in the group management server 4 and the pieces of semiconductor manufacturing equipment 5, 6, and 7 (i.e., the user authentication information databases 4a, 5a, 6a, and 7a) is used as master information for authenticating the user. Specifically, in the case of remote maintenance/diagnosis, the user is authenticated by reference to the copied user authentication information produced from the user authentication information owned by the semiconductor manufacturing equipment 5, 6, and 7. The copied user authentication information is identical in content with the user authentication information employed when access is made directly rather than remotely to the group management server 4 or the pieces of the semiconductor manufacturing equipment 5, 6, and 7.

Therefore, even in the case of remote maintenance/diagnosis, security analogous to that achieved in a case where maintenance/diagnosis is performed directly rather than remotely can be maintained between the equipment which performs maintenance/diagnosis (i.e., equipment which performs remote diagnosis) and the equipment to be subjected to maintenance/diagnosis (i.e., the owner of the equipment). Further, the necessity for elaborate maintenance of the user authentication information attributable to the fact that the maintenance/diagnosis data storage server 23A is basically provided as a common server regardless of the number of manufacturers of semiconductor manufacturing equipment is also reduced considerably.

Moreover, in this case, user authentication itself does not involve a necessity for making an access to equipment (i.e., the group management server 4 and the pieces of semiconductor manufacturing equipment 5, 6, and 7). Even when a malfunction has arisen in the equipment, the maintenance/diagnosis data are transferred to the Internet 25, thereby enabling reliable remote maintenance/diagnosis. When maintenance/diagnosis is required, a malfunction may has arisen in the equipment, and hence this will become a great advantage.

There is a conceivable case where the copied user authentication information owned by the maintenance/diagnosis data storage server 23A is destroyed for a reason that the maintenance/diagnosis data storage server 23A is in the DMZ. However, even in such a case, the copied user authentication information can be recovered by means of using the user authentication information owned by the group management server 4 and the pieces of semiconductor manufacturing equipment 5, 6, and 7 as master information. Moreover, when viewed from the group management server 4 and the pieces of semiconductor manufacturing equipment 5, 6, and 7, copying of the user authentication information is performed in only one direction with respect to the maintenance/diagnosis data storage server 23A, and safety of the master information can also be maintained.

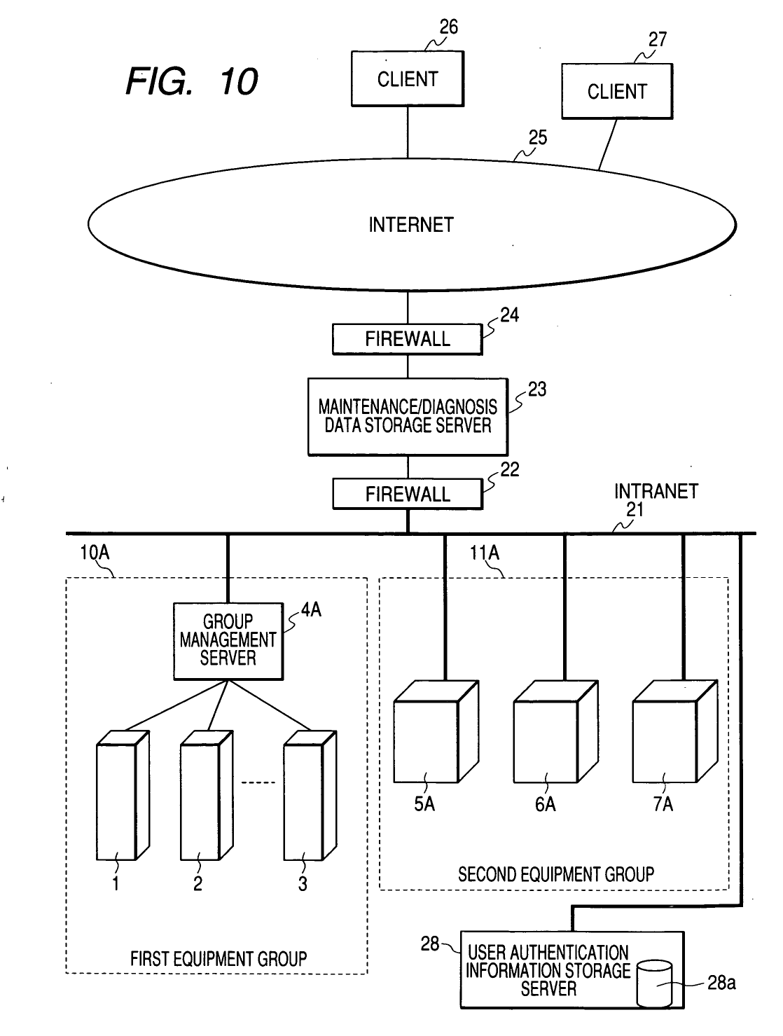

Next, a maintenance/diagnosis data storage server, and a system for storing maintenance/diagnosis data, all pertaining to a third embodiment of the present invention, will be described by reference to FIG. 10. FIG. 10 is a view showing a configuration achieved when the maintenance/diagnosis data storage server, the system for storing maintenance/diagnosis data, all pertaining to the third embodiment of the present invention, are used for a semiconductor manufacturing apparatus which is to be subjected to maintenance and diagnosis. Those constituent elements which have already been described by reference to FIG. 10 are assigned the same reference numerals, and their repeated explanations are omitted herein.

A difference between the third embodiment and the previously-described first and second embodiments lies in that the intranet 21 is provided with a user authentication information storage server 28. A user authentication information database 28a of the user authentication information storage server 28 is configured to retain, in a unified manner, user authentication information items of a group management server 4A and those of pieces of semiconductor manufacturing equipment 5A, 6A, and 7A. As a result, the group management server 4A and the pieces of semiconductor manufacturing equipment 5A, 6A, and 7A are not required to individually retain user authentication information items, and hence they may dispense with their user authentication information databases.

When a data access request has been made by the clients 26, 27 via the Internet 25, the maintenance/diagnosis data storage server 23 requests the user authentication information storage server 28 to authenticate the user by way of the firewall 22 and the intranet 21 on the basis of the data access request and receives a result of authentication. When the received result of authentication is normal, the stored maintenance/diagnosis data are output to the clients 26, 27 on the basis of the data access request.

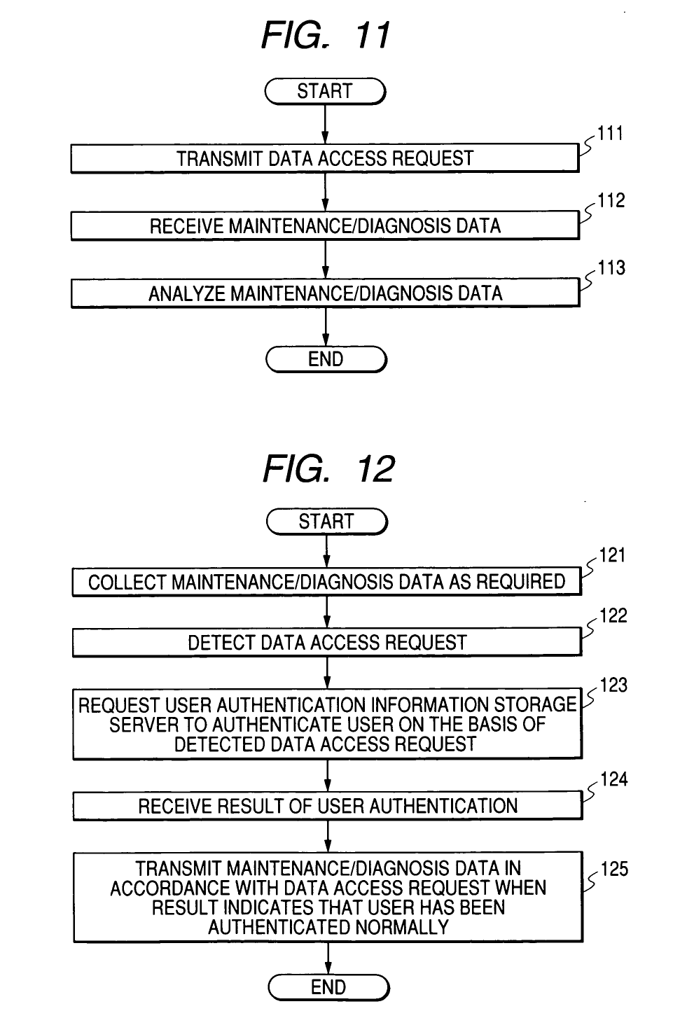

Next, operation of the configuration shown in FIG. 10 will be described by reference to the flowcharts shown in FIGS. 11 through 14. FIG. 11 is a flowchart showing the flow of operation of the client 26 (27) shown in FIG. 10. As shown in FIG. 11, the client 26 (27) first transmits a data access request to the maintenance/diagnosis data storage server 23 by way of the firewall 24 over the Internet 25 (step 111). The data access request includes a request for user authentication and a request for outputting a desired data set from the stored maintenance/diagnosis data.

As will be described later, if the maintenance/diagnosis data storage server 23 responds to the request and performs normal operation, the maintenance/diagnosis data storage server 23 outputs and transmits the maintenance/diagnosis data. Thus, the client 26 (27) receives the data by way of the firewall 24 over the Internet 25 (step 112). The thus-received data are analyzed, and maintenance/diagnosis processing is performed (step 113). Subsequently, on the basis of the result of processing software, such as a prescription program, may be transmitted to the maintenance/diagnosis data storage server 23 by way of the Internet 25 and the firewall 24. The operation shown in FIG. 11 is identical with the operation that has already been described and is shown in FIGS. 3 and 7.

FIG. 12 is a flowchart showing the flow of operation of the maintenance/diagnosis data storage server 23 shown in FIG. 10. As shown in FIG. 12, the maintenance/diagnosis data storage server 23 collects and stores maintenance/diagnosis data from the group management server 4A or the pieces of semiconductor manufacturing equipment 5A, 6A, and 7A by way of the firewall 22 and the intranet 21, as required (step 121). The collection and storing operations can be performed periodically or nonperiodically.

A data access request from the clients 26, 27 via the Internet 25 is monitored and detected (step S122). If the data access request has been detected, the user authentication information storage server 28 is required to authenticate the user by way of the firewall 22 and the intranet 21 (step 123). The reason for this is that the user authentication information storage server 28 holds the user authentication information items of a group management server 4A and those of pieces of semiconductor manufacturing equipment 5A, 6A, and 7A in a unified manner (as has been described, the user authentication information is held in the user authentication information database 28a). On the basis of the data access request, the semiconductor manufacturing equipment or the equipment group, which is an object of user authentication, is specified.

In response to the request for user authentication, user authentication pertaining to the specified pieces of semiconductor manufacturing equipment 5A, 6A, 7A or user authentication pertaining to the specified group management server 4A is executed by the user authentication information storage server 28 in a manner which will be described later. If the user authentication is executed normally, a result of user authentication is transmitted. The maintenance/diagnosis data storage server 23 receives the result by way of the intranet 21 and the firewall 22 (step 124).

When the result indicates that the user has been authenticated normally, a desired data set from among the stored maintenance/diagnosis data is output and transmitted to the Internet 25 by way of the firewall 24 in accordance with the data access request (step 125). The thus-transmitted data are received by the client 26 (27) over the Internet 25, as mentioned previously.

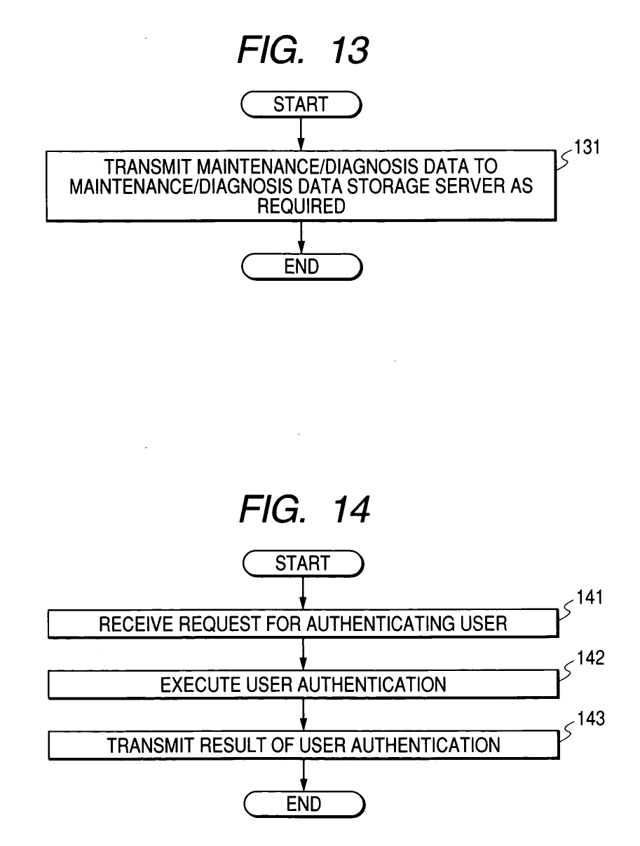

FIG. 13 is a flowchart showing the flow of operation of the group management server 4A or operations of the pieces of the semiconductor manufacturing equipment 5A, 6A, and 7A, which are shown in FIG. 10. Here, only operations which arise as a result of establishment of connection with the intranet 21 are described as operations of the pieces of semiconductor manufacturing equipment 5A, 6A, and 7A. As a matter of course, operations intrinsic to manufacture of a semiconductor (e.g., the operation of the resist coating/development apparatus) are performed separately.

By way of the intranet 21 and the firewall 22, the group management server 4A or the pieces of semiconductor manufacturing equipment 5A, 6A, and 7A send the maintenance/diagnosis data pertaining to the semiconductor manufacturing equipment under control of the group management server 4A or the maintenance/diagnosis data pertaining to the semiconductor manufacturing equipment 5A, 6A, and 7A to the maintenance/diagnosis data storage server 23, as required (step 131). This operation can be performed periodically or nonperiodically.

FIG. 14 is a flowchart showing flow of operation of the user authentication information storage server 28 shown in FIG. 10. The user authentication information storage server 28 is in standby condition so as to be able to receive a request for user authentication from the maintenance/diagnosis data storage server 23 (step 141). The request for user authentication is made by means of specifying semiconductor manufacturing equipment or an equipment group, which is an object of the request. Upon receipt of the request over the intranet 21, the user authentication information storage server 28 executes the request by reference to the user authentication information stored in the user authentication information database 28a (step 142). A result of execution is transmitted to the maintenance/diagnosis data storage server 23 by way of the intranet 21 and the firewall 22 (step 143).

By means of the configuration that has been described thus far and comprises the client 26 (27), the maintenance/diagnosis data storage server 23, the group management server 4A, and the pieces of semiconductor manufacturing equipment 5A, 6A, and 7A, as well, the same result of user authentication is yielded, regardless of whether maintenance/diagnosis is performed remotely or a maintenance engineer visits the production plant where the pieces of semiconductor manufacturing equipment 1, 2, 3, 5A, 6A, and 7A are installed and directly performs maintenance/diagnosis of these pieces of semiconductor manufacturing equipment.

The reason for this is that these two cases are identical with each other in terms of user authentication being performed through use of the user authentication information stored in the user authentication information storage server 28 (i.e., the user authentication information database 28a). Specifically, in the case of remote maintenance/diagnosis, user authentication is performed by reference to the user authentication information stored in the user authentication information storage server 28. The user authentication information employed at that time is identical with that used when access is made not remotely but directly to the group management server 4A or the respective pieces of semiconductor manufacturing equipment 5A, 6A, and 7A (in this case, the group management server 4A or the pieces of semiconductor manufacturing equipment 5A, 6A, and 7A request the user authentication information storage server 28 to authenticate the user by way of the intranet 21).

Therefore, even in the case of remote maintenance/diagnosis, security analogous to that achieved in a case where maintenance/diagnosis is performed directly rather than remotely can be maintained between the equipment which performs maintenance/diagnosis (i.e., equipment which performs remote diagnosis) and the equipment to be subjected to maintenance/diagnosis (i.e., the owner of the equipment). Further, the necessity for elaborate maintenance of the user authentication information attributable to the fact that the maintenance/diagnosis data storage server 23 is basically provided as a common server regardless of the number of manufacturers of semiconductor manufacturing equipment is also reduced considerably.

Moreover, in this case, user authentication itself does not involve a necessity for making an access to equipment (i.e., the group management server 4A and the pieces of semiconductor manufacturing equipment 5A, 6A, and 7A). Even when a malfunction has arisen in the equipment, the maintenance/diagnosis data are transferred to the Internet 25, thereby enabling reliable remote maintenance/diagnosis. When maintenance/diagnosis is required, a malfunction may have arisen in the equipment, and hence this will become a great advantage.

Further, in this case, there is no necessity for placing the user authentication information in the DMZ, and hence security of the user authentication information is enhanced. Moreover, the user authentication information is managed by the user authentication information storage server 28 in a unified manner. Hence, when the equipment is connected to a number of networks, efforts associated with maintenance and updating of the user authentication information can be lessened.

In the third embodiment, the authentication is performed by the user authentication information storage server 28. However, the authentication may be performed by the maintenance/diagnosis data storage server 23.

The embodiments have been described by means of taking the semiconductor manufacturing equipment as equipment to be subjected to maintenance and diagnosis. However, the invention is not limited to the equipment set forth but can be applied to any equipment in the same manner, so long as the equipment is connectable to a network (i.e., the intranet 21).

As has been described in detail, according to the present invention, even in the case of remote maintenance/diagnosis, security analogous to that achieved in a case where maintenance/diagnosis is performed directly rather than remotely can be maintained.

As described above, according to one aspect of the invention, the maintenance/diagnosis data storage server is connected to a first network by way of a firewall having a lower security level and connected to a second network by way of a firewall having a higher security level. A data access request output from the first network is detected, and equipment connected to the second network is requested to authenticate a user in accordance with the detected data access request. A result of authentication is acquired by way of the second network. If the user has been normally authenticated, the stored maintenance/diagnosis data pertaining to the equipment are output to the first network.

Consequently, in the case of remote maintenance/diagnosis, user authentication is performed by direct reference to the user authentication information owned by the equipment, thereby obtaining a result of user authentication analogous to that obtained when maintenance and diagnosis are performed not remotely and when the equipment is caused to authenticate the user. Therefore, even in the case of remote maintenance/diagnosis, an attempt can be made to maintain security analogous to that achieved in a case where maintenance and diagnosis are performed not remotely.

In the above description, the first network is the Internet, and the second network is an intranet. As mentioned above, firewalls having different security levels are interposed between these networks, whereby the maintenance/diagnosis data storage server is situated in a so-called DMZ (demilitarized zone). An access from the Internet is limited to this server, whereby intrusion to the intranet is prevented. Hence, in a general sense, an attempt to maintain security can be made.

According to another aspect of the invention, a system including a maintenance/diagnosis data storage server and a maintenance/diagnosis data acquisition client connectable with the first network by way of the first network, is achieved. The maintenance/diagnosis data acquisition client issues a data access request. In response to this request, the user is authenticated by means of the configuration of the server. When maintenance/diagnosis data are output, the thus-output maintenance/diagnosis data re received.

Consequently, in the case of remote maintenance/diagnosis, user authentication is performed by direct reference to the user authentication information owned by the equipment, thereby obtaining a result of user authentication analogous to that obtained when maintenance and diagnosis are performed not remotely and when the equipment is caused to authenticate the user. Therefore, even in the case of remote maintenance/diagnosis, an attempt can be made to maintain security analogous to that achieved in a case where maintenance and diagnosis are performed not remotely.

According to another aspect of the invention, a system including the maintenance/diagnosis data storage server and equipment (equipment which is to be subjected to maintenance/diagnosis) connected with the server by way of a network, is achieved. The equipment has means for transferring maintenance/diagnosis data pertaining to itself to the maintenance/diagnosis data storage server. Further, the equipment further includes means for performing the requested user authentication on the basis of the owned user authentication information, and means for transmitting a result of the executed user authentication to the maintenance/diagnosis data storage server.

Consequently, in the case of remote maintenance/diagnosis, user authentication is performed by direct reference to the user authentication information owned by the equipment, thereby obtaining a result of user authentication analogous to that obtained when maintenance and diagnosis are performed not remotely and when the equipment is caused to authenticate the user. Therefore, even in the case of remote maintenance/diagnosis, an attempt can be made to maintain security analogous to that achieved in a case where maintenance and diagnosis are performed not remotely. (Here, the terms “first” and “second” denote the sequence in which the elements have appeared.)

According to another aspect of the invention, the maintenance/diagnosis data server may be used in the DMZ. In this case, the user authentication information owned by the equipment is copied and that the maintenance/diagnosis data storage server retains those data. Consequently, in the case of remote maintenance/diagnosis, user authentication is performed by reference to the copy of the user authentication information owned by the equipment. There is obtained a result of user authentication analogous to that obtained when maintenance/diagnosis is performed not remotely and when the equipment is caused to authenticate the user. Therefore, even in the case of remote maintenance/diagnosis, an attempt can be made to maintain security analogous to that achieved in a case where maintenance/diagnosis is performed not remotely.

Moreover, in this case, user authentication itself does not involve a necessity for making an access to equipment (i.e., equipment which is to be subjected to maintenance/diagnosis). Even when a malfunction has arisen in the equipment, the maintenance/diagnosis data are transferred to the network, thereby enabling reliable remote maintenance/diagnosis. There is also a conceivable case where the copied user authentication information owned by the server is destroyed for a reason that the maintenance/diagnosis data storage server is in the DMZ. However, even in such a case, the copied user authentication information can be recovered by means of using the user authentication information owned by the equipment as master information.

According to another aspect of the invention, the system may include the maintenance/diagnosis data storage server and the maintenance/diagnosis data acquisition client connectable by way of the first network. The maintenance/diagnosis data acquisition client issues a data access request. In response to this request, the user is authenticated by means of the configuration of the server. When maintenance/diagnosis data have been output, the thus-output maintenance/diagnosis data are received.

Consequently, in the case of remote maintenance/diagnosis, user authentication is performed by direct reference to the copied user authentication information in the same manner as mentioned previously, thereby obtaining a result of user authentication analogous to that obtained when maintenance/diagnosis is performed not remotely and when the equipment is caused to authenticate the user. Therefore, even in the case of remote maintenance/diagnosis, an attempt can be made to maintain security analogous to that achieved in a case where maintenance/diagnosis is performed not remotely.

Moreover, in this case, user authentication itself does not involve a necessity for making an access to equipment (i.e., equipment which is to be subjected to maintenance/diagnosis). Even when a malfunction has arisen in the equipment, the maintenance/diagnosis data are transferred to the network, thereby enabling reliable remote maintenance/diagnosis. There is also a conceivable case where the copied user authentication information owned by the server is destroyed for a reason that the maintenance/diagnosis data storage server is in the DMZ. However, even in such a case, the copied user authentication information can be recovered by means of using the user authentication information owned by the equipment as master information.

According to another aspect of the invention, the system may include the maintenance/diagnosis data storage server and equipment (equipment which is to be subjected to maintenance/diagnosis) connected with the server by way of a network. The equipment has means for transferring maintenance/diagnosis data pertaining to itself to the maintenance/diagnosis data storage server. Further, the equipment further comprises means for transmitting a result of the executed user authentication to the maintenance/diagnosis data storage server. The maintenance/diagnosis data storage server retains the thus-transmitted user authentication information as copied user authentication information.

Consequently, in the case of remote maintenance/diagnosis, user authentication is performed by reference to the copied user authentication information, thereby obtaining a result of user authentication analogous to that obtained when maintenance/diagnosis is performed not remotely and when the equipment is caused to authenticate the user. Therefore, even in the case of remote maintenance/diagnosis, an attempt can be made to maintain security analogous to that achieved in a case where maintenance/diagnosis is performed not remotely. (Here, the terms “first” and “second” denote the sequence in which the elements have appeared.)

Moreover, in this case, user authentication itself does not involve a necessity for making an access to equipment (i.e., equipment which is to be subjected to maintenance/diagnosis). Even when a malfunction has arisen in the equipment, the maintenance/diagnosis data are transferred to the network, thereby enabling reliable remote maintenance/diagnosis. There is also a conceivable case where the copied user authentication information owned by the server is destroyed for a reason that the maintenance/diagnosis data storage server is in the DMZ. However, even in such a case, the copied user authentication information can be recovered by means of using the user authentication information owned by the equipment as master information.

According to another aspect of the invention, user authentication information items owned by individual pieces of equipment may be managed in a unified manner and retained in the maintenance/diagnosis data storage server. Consequently, in the case of remote maintenance/diagnosis, user authentication is performed by reference directly to the user authentication information in the same manner as mentioned previously. There is obtained a result of user authentication analogous to that obtained when maintenance/diagnosis is performed not remotely and when the equipment is caused to authenticate the user. Therefore, even in the case of remote maintenance/diagnosis, an attempt can be made to maintain security analogous to that achieved in a case where maintenance/diagnosis is performed not remotely.

Moreover, in this case, there is no necessity for placing the user authentication information in the DMZ, thereby enabling an attempt to enhance security of the user authentication information. Moreover, user authentication itself does not involve a necessity for making an access to equipment (i.e., equipment which is to be subjected to maintenance/diagnosis). Even when a malfunction has arisen in the equipment, the maintenance/diagnosis data are transferred to the network, thereby enabling reliable remote maintenance/diagnosis. Moreover, the user authentication information is managed in a unified manner, and hence, when the equipment is connected to a number of networks, efforts associated with maintenance and updating of the user authentication information can be lessened.

According to another aspect of the invention, the system may include the maintenance/diagnosis data storage server and the maintenance/diagnosis data acquisition client connectable with the first network by way of the first network. The maintenance/diagnosis data acquisition client issues a data access request. In response to the request, the user is authenticated by means of the configuration of the server. When maintenance/diagnosis data are output, the thus-output maintenance/diagnosis data re received.

Consequently, in the case of remote maintenance/diagnosis, user authentication is performed by direct reference to the user authentication information owned by the equipment, thereby obtaining a result of user authentication analogous to that obtained when maintenance/diagnosis is performed not remotely and when the equipment is caused to authenticate the user. Therefore, even in the case of remote maintenance/diagnosis, an attempt can be made to maintain security analogous to that achieved in a case where maintenance/diagnosis is performed not remotely.

Moreover, in this case, there is no necessity for placing the user authentication information in the DMZ, thereby enabling an attempt to enhance security of the user authentication information. Moreover, user authentication itself does not involve a necessity for making an access to equipment (i.e., equipment which is to be subjected to maintenance/diagnosis). Even when a malfunction has arisen in the equipment, the maintenance/diagnosis data are transferred to the network, thereby enabling reliable remote maintenance/diagnosis. Moreover, the user authentication information is managed in a unified manner, and hence, when the equipment is connected to a number of networks, efforts associated with maintenance and updating of the user authentication information can be lessened.

According to another aspect of the invention, the system may include: the maintenance/diagnosis data storage server; the equipment (equipment which is to be subjected to maintenance/diagnosis) connected to the server over a network; and the user authentication information storage server connected to the server over the network. The equipment has means for transferring maintenance/diagnosis data pertaining to itself to the maintenance/diagnosis data storage server. The user authentication information is retained by the user authentication information storage server in a unified manner.

Consequently, in the case of remote maintenance/diagnosis, user authentication is performed by direct reference to the user authentication information owned by the equipment, thereby obtaining a result of user authentication analogous to that obtained when maintenance/diagnosis is performed not remotely and when the equipment is caused to authenticate the user. Therefore, even in the case of remote maintenance/diagnosis, an attempt can be made to maintain security analogous to that achieved in a case where maintenance/diagnosis is performed not remotely. (Here, the terms “first” and “second” denote the sequence in which the elements have appeared.)

Moreover, in this case, there is no necessity for placing the user authentication information in the DMZ, thereby enabling an attempt to enhance security of the user authentication information. Moreover, user authentication itself does not involve a necessity for making an access to equipment (i.e., equipment which is to be subjected to maintenance/diagnosis). Even when a malfunction has arisen in the equipment, the maintenance/diagnosis data are transferred to the network, thereby enabling reliable remote maintenance/diagnosis. Moreover, the user authentication information is managed in a unified manner, and hence, when the equipment is connected to a number of networks, efforts associated with maintenance and updating of the user authentication information can be lessened.

Although, the maintenance/diagnosis data may be arbitrary, one example of the maintenance/diagnosis data will be described herein, in a case where the equipment which is to be subjected to the maintenance and diagnosis is an apparatus that performs plasma etching. In this case, the maintenance/diagnosis data may include the values indicating: a pressure in a chamber; a revolution speed of turbo molecular pump; positions of a pressure control valve provided between the turbo molecular pump and the chamber; a volume of a cooling water; flow rate of nitrogen gas; and forward and reverse of an RF power.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A maintenance/diagnosis data storage server comprising:
a data storing unit that obtains maintenance/diagnosis data pertaining to equipment that is connected to a first network, from the equipment via a first firewall, and stores the maintenance/diagnosis data;
a request receiving unit that receives a data access request in which to request an access to the maintenance/diagnosis data, from a client provided for obtaining data and connected to a second network, via a second firewall;
an authenticating unit that authenticates the data access request based on authentication information; and
a data transmitting unit that transmits the maintenance/diagnosis data stored in the data storing unit to the client via the second firewall in a case where the authenticating unit authenticates the data access request is valid.

2. The maintenance/diagnosis data storage server according to claim 1, wherein the authenticating unit comprises:
an authentication request transmitting section that transmits an authentication request to the equipment; and
an authentication result receiving section that receives an authentication result made by the equipment based on the authentication information stored in the equipment.

3. The maintenance/diagnosis data storage server according to claim 1, wherein the authenticating unit comprises:
an authentication information obtaining section that obtains the authentication information stored in the equipment, from the equipment; and
an authentication performing section that performs an authentication of the data access request based on the authentication information obtained by the authentication information obtaining section.

4. The maintenance/diagnosis data storage server according to claim 1, wherein the authenticating unit comprises:
a copied authentication information storing section that obtains the authentication information stored in the equipment via the first firewall, and stores the authentication information as a copied authentication information; and
an authentication performing section that performs an authentication of the data access request based on the copied authentication information stored in the copied authentication information storing section.

5. The maintenance/diagnosis data storage server according to claim 1, wherein the authenticating unit comprises:
an authentication request transmitting section that transmits an authentication request via the first firewall to an authentication information storage server that is connected to the first network; and
an authentication result receiving section that receives an authentication result made by the authentication information storage server based on the authentication information stored in the authentication information storage server.

6. The maintenance/diagnosis data storage server according to claim 1, wherein the authenticating unit comprises:
an authentication information obtaining section that obtains the authentication information stored in an authentication information storage server that is connected to the first network, from the authentication information storage server via the first firewall; and
an authentication performing section that performs an authentication of the data access request based on the authentication information obtained by the authentication information obtaining section.

7. The maintenance/diagnosis data storage server according to claim 1, wherein a security level of the first firewall is configured to be higher than that of the second firewall.

8. A maintenance/diagnosis data storage system comprising:
a maintenance/diagnosis data storage server connected to a first network via a first firewall; and
a client for obtaining a maintenance/diagnosis data connected to the first network,
wherein the client comprises:
a request transmitting unit that transmits a data access request in which to request an access to maintenance/diagnosis data, to the maintenance/diagnosis data server via the first firewall; and
a data receiving unit that receives the maintenance/diagnosis data from the maintenance/diagnosis data server via the first firewall,
wherein the maintenance/diagnosis data server comprises:
a data storing unit that obtains the maintenance/diagnosis data pertaining to equipment that is connected to a second network, from the equipment via a second firewall, and stores the maintenance/diagnosis data;
a request receiving unit that receives the data access request from the client;
an authenticating unit that authenticates the data access request based on authentication information; and
a data transmitting unit that transmits the maintenance/diagnosis data stored in the data storing unit to the client via the first firewall in a case where the authenticating unit authenticates the data access request is valid.

9. The maintenance/diagnosis data storage system according to claim 8, wherein the authenticating unit comprises:
an authentication request transmitting section that transmits an authentication request to the equipment; and
an authentication result receiving section that receives an authentication result made by the equipment based on the authentication information stored in the equipment.

10. The maintenance/diagnosis data storage system according to claim 8, wherein the authenticating unit comprises:
an authentication information obtaining section that obtains the authentication information stored in the equipment, from the equipment; and
an authentication performing section that performs an authentication of the data access request based on the authentication information obtained by the authentication information obtaining section.

11. The maintenance/diagnosis data storage system according to claim 8, wherein the authenticating unit comprises:
a copied authentication information storing section that obtains the authentication information stored in the equipment via the second firewall, and stores the authentication information as a copied authentication information; and
an authentication performing section that performs an authentication of the data access request based on the copied authentication information stored in the copied authentication information storing section.

12. The maintenance/diagnosis data storage system according to claim 8, wherein the authenticating unit comprises:
an authentication request transmitting section that transmits an authentication request via the second firewall to an authentication information storage server that is connected to the second network; and
an authentication result receiving section that receives an authentication result made by the authentication information storage server based on the authentication information stored in the authentication information storage server.

13. The maintenance/diagnosis data storage system according to claim 8, wherein the authenticating unit comprises:
an authentication information obtaining section that obtains the authentication information stored in an authentication information storage server that is connected to the second network, from the authentication information storage server via the second firewall; and
an authentication performing section that performs an authentication of the data access request based on the authentication information obtained by the authentication information obtaining section.

14. The maintenance/diagnosis data storage system according to claim 8, wherein a security level of the second firewall is configured to be higher than that of the first firewall.

15. A maintenance/diagnosis data storage system comprising:
an equipment connected to a first network; and
a maintenance/diagnosis data storage server connected to the first network via a first firewall, and connected to a second network via a second firewall,
wherein the maintenance/diagnosis data storage server comprises:
a data storing unit that obtains maintenance/diagnosis data pertaining to the equipment, from the equipment via a first firewall, and stores the maintenance/diagnosis data;
a request receiving unit that receives a data access request in which to request an access to the maintenance/diagnosis data, from a client provided for obtaining data and connected to the second network, via the second firewall;
an authenticating unit that authenticates the data access request based on authentication information; and
a data transmitting unit that transmits the maintenance/diagnosis data stored in the data storing unit to the client via the second firewall in a case where the authenticating unit authenticates the data access request is valid.

16. The maintenance/diagnosis data storage system according to claim 15, wherein the authenticating unit comprises:
an authentication request transmitting section that transmits an authentication request to the equipment; and
an authentication result receiving section that receives an authentication result made by the equipment based on the authentication information stored in the equipment.

17. The maintenance/diagnosis data storage system according to claim 15, wherein the authenticating unit comprises:
an authentication information obtaining section that obtains the authentication information stored in the equipment, from the equipment; and
an authentication performing section that performs an authentication of the data access request based on the authentication information obtained by the authentication information obtaining section.

18. The maintenance/diagnosis data storage system according to claim 15, wherein the authenticating unit comprises:
a copied authentication information storing section that obtains the authentication information stored in the equipment via the first firewall, and stores the authentication information as a copied authentication information; and
an authentication performing section that performs an authentication of the data access request based on the copied authentication information stored in the copied authentication information storing section.

19. The maintenance/diagnosis data storage system according to claim 15, wherein the authenticating unit comprises:
an authentication request transmitting section that transmits an authentication request via the first firewall to an authentication information storage server that is connected to the first network; and
an authentication result receiving section that receives an authentication result made by the authentication information storage server based on the authentication information stored in the authentication information storage server.

20. The maintenance/diagnosis data storage system according to claim 15, wherein the authenticating unit comprises:
an authentication information obtaining section that obtains the authentication information stored in an authentication information storage server that is connected to the first network, from the authentication information storage server via the first firewall; and
an authentication performing section that performs an authentication of the data access request based on the authentication information obtained by the authentication information obtaining section.

21. The maintenance/diagnosis data storage system according to claim 15, wherein a security level of the first firewall is configured to be higher than that of the second firewall.
